(19) United States
(12) Patent Application Publication
(10) Pub. No.: US 2011/0257926 A1
(43) Pub. Date: Oct. 20, 2011

(54) METHOD FOR THE ANALYSIS OF THE THERMAL BEHAVIOUR OF A STRUCTURE AND ASSOCIATED SYSTEM

(75) Inventors: Jerome Stubler, Paris (FR); Bernard Basile, Plaisir (FR); Gilles Hovhanessian, Antony (FR)

(73) Assignee: Soletanche Freyssinet, Rueil Malmaison (FR)

(21) Appl. No.: 13/087,605

(22) Filed: Apr. 15, 2011

(30) Foreign Application Priority Data
Apr. 16, 2010 (FR) 1052910

(51) Int. Cl. G01K 1/02; G06F 15/00

(52) U.S. Cl. 702/136

(57) ABSTRACT

Method for the analysis of the thermal behaviour of a structure including an energy-consuming appliance for providing a thermal environment by heating or cooling, the structure being modelled using a thermal model so that a relationship between a theoretical consumption by said appliance and a reference temperature inside the structure satisfies a determined criterion. According to this method, an actual consumption by said appliance, a temperature actually obtained inside the structure and at least one parameter relating to a use of the structure are measured; a variation between the aforesaid relationship and a corresponding relationship between the actual consumption by said appliance and the temperature actually obtained inside the structure are estimated; and when the estimated variation exceeds a threshold, a contribution relating to the use of the structure to said variation is estimated by taking account of said measured parameter.

This application claims priority to French Application No. 1052910, filed on Apr. 16, 2010 which is hereby incorporated by reference in its entirety as if fully set forth herein.

### BACKGROUND OF THE INVENTION

The present invention relates to the analysis of the thermal behaviour of a structure.

Any structure delimiting an enclosed space and including at least one energy-consuming appliance, for example electrical, for providing a thermal environment (heating or air-conditioning) that is different to the one prevailing outside can be seen as a site of exchange and circulation of thermal energy.

This is represented very diagrammatically in FIG. 1. The structure 1, which can for example be a building, a hall, a room, a premises or any other structure delimiting an enclosed space, contains an appliance 2 for heating (boiler, radiator, etc.) or cooling (air-conditioning, etc.).

The heat or the cold produced by the appliance 2 constitutes a heat flow that propagates within the structure 1, as symbolized by the arrows 3. A part of this thermal energy is moreover lost and escapes from the structure 1, as symbolized by the arrows 4.

One way of improving the heat balance of the structure 1 is therefore to ensure that the losses 4 are minimized, for example by working on the sealing and insulation of the structure 1.

On the other hand, there is currently a strong trend towards improving the energy performance of structures, whether they are intended for residential, business, industrial or other use.

In the case of the structure 1 in FIG. 1, the energy performance is improved the lower the energy consumption by the appliance 2, whilst keeping control over the temperature inside the structure 1.

Standards in force or in the process of preparation thus provide for drastic reductions in the average energy consumption in the building sector to be imposed in the relatively short term.

For these reasons, the design of a structure must from now on take account of the energy balance. This is generally carried out using computerized simulation tools.

The designers of a structure are even sometimes required to commit to an energy balance. To this end, they may have to guarantee that a relationship between a theoretical consumption by the appliance(s) intended to provide a thermal environment in the structure and a reference temperature inside the structure meets a determined criterion. By way of example, the commitment can consist of guaranteeing a consumption of less than a certain quantity of primary energy per unit of surface area annually (expressed for example in kWhep/m²/year) for a certain average inside temperature (expressed for example in degrees Celsius).

Such a commitment can be provided thanks to a sound knowledge, by the designers, of the physical properties of their structure, allowing a thermal model thereof to be designed. Hypotheses are moreover based on the variable parameters which can affect the energy balance, such as the meteorological conditions (insolation level, outside temperature, or other). If not completely ignored, the variable parameters associated with the use of the structure may equally be the subject of very simplified statistical hypotheses. By use of the structure is meant any variable phenomenon that is capable of alteration by a human intervention, for example on the initiative of an occupant of the structure, and having an effect on the heat flows in the structure. The thermal model formalizes the relationship between the input energy, the environment, the use of the structure and the inside temperature.

Once the thus-designed structure has been completed, it can be useful to verify if it does actually satisfy the commitment of its designers in terms of energy balance.

For this purpose, it is known to monitor the energy consumption by the heating or cooling appliances. This is carried out in standard fashion using manual reports from meters that are performed at relatively long time intervals, typically of the order of a month or a year. In a variant, suitable sensors can allow more regular monitoring of the consumption.

However, the consumption thus obtained cannot necessarily be exploited, as it can result from actual conditions that are different from the hypotheses set during the design. It can in particular involve conditions of use of the structure that are different to those envisaged at the design stage: for example due to the addition or removal of neighbouring screens of trees that project a shadow onto the structure in question, due to the occupation of the structure by a number of persons that is greater or smaller than the starting hypothesis, etc.

It can therefore be difficult to verify if the commitment entered into by the designers has been satisfied or not.

In the case where the commitment does not appear to have been satisfied, due to the fact for example that the actual energy consumption is greater than the stated threshold, this could sometimes be explained entirely by the variation between the actual conditions of use of the structure and the theoretical hypotheses retained during the design stage.

Thus, the known methods do not make it possible to decide whether or not the commitments in terms of energy balance have been respected, as they do not allow all the reasons capable of explaining an unexpected level of measured consumption to be known. Furthermore they do not make it possible to review the performance commitments as a function of the actual conditions of use.

### SUMMARY OF THE INVENTION

An object of the present invention is to improve this situation by allowing an analysis of the thermal behaviour of a structure.

The invention thus proposes a method for the analysis of the thermal behaviour of a structure delimiting an enclosed space and including at least one energy-consuming appliance for providing a thermal environment by heating or cooling, the structure being modelled using a thermal model so that a relationship between a theoretical consumption by said appliance and a reference temperature inside the structure satisfies a determined criterion. The method comprises the following steps:
measuring an actual consumption by said appliance, a temperature actually obtained inside the structure and at least one parameter relating to a use of the structure;
estimating a variation between said relationship between a theoretical consumption by said appliance and a reference temperature inside the structure on the one hand and a corresponding relationship between the actual consumption by said appliance and the temperature actually obtained inside the structure on the other hand; and
when the estimated variation exceeds a threshold, estimating a contribution relating to the use of the structure to said variation by taking account of said measured parameter.

The estimation of a contribution relating to the use of the structure makes it possible to know how the use of this structure was able to affect the consumption by the heating or cooling appliance. By way of non-limitative example, the presence of an unusually high number of persons in the structure can explain, through the heat that it produces, a particularly low consumption by a heating appliance. Conversely, the opening of a large number of windows and/or doors of the structure, in particular when accompanied by a low outside temperature, can explain a particularly high consumption by a heating appliance. Many other types of use of the structure can impact on the energy consumption in various ways.

Advantageously, the estimated contribution relating to the use of the structure can be used in order to calculate a corrected variation by subtracting from said estimated variation the contribution relating to the use of the structure. Such a corrected variation is thus intended to disregard the effect of the use of the structure. It reflects any deviation in consumption in relation to behaviour expected at the design stage.

This deviation can be indicative of a poor calibration of the thermal model used during the design of the structure and/or of non-respect of any commitment by the designers of the structure. In the first case, the corrected variation can advantageously be exploited in order to calibrate the thermal model, taking account of the actual observed situation. In the second case, the extent of the corrected variation, optionally complemented by additional investigations, can allow the causes of the deviation to be understood or even corrected.

According to other advantageous embodiments which can be combined in all the ways that can be envisaged:
a corrected variation is moreover calculated by subtracting from said estimated variation the contribution relating to the use of the structure;
a conclusion is deduced with respect to the design of the structure, from the corrected variation; it is thus possible to assess if commitments made at the design stage have or have not been respected, taking account of the use of the structure;
the thermal model is modified in order to take account of the corrected variation; it is thus possible to make the thermal model conform more closely to the actual situation;
moreover, using corresponding sensors, parameters relating to the environment of the structure are measured, such as meteorological conditions or a thermal environment of an adjacent structure, and said relationship between the actual consumption by said appliance and the temperature actually obtained inside the structure takes account of at least some of these parameters;
said parameter relating to a use of the structure relates to at least one of: an opening/closing of at least one door or window in the structure, covering at least one door or window in the structure, presence of at least one individual inside the structure, presence of at least one indirect source of heat or cold inside the structure, use of at least one operational setting for said appliance;
at least one image is obtained displaying a thermal distribution in the structure by means of at least one thermal camera, said obtained image being used in order to measure said parameter relating to a use of the structure; the latter being a particularly simple way of measuring said parameter;
said parameter relating to a use of the structure is measured based on a comparison between said obtained image and a corresponding expected image;
said expected image takes account of the presence and the location in the structure of said energy-consuming appliance for providing a thermal environment by heating or cooling;
said obtained image can be in an encrypted form;
the actual consumption by said appliance and the temperature actually obtained inside the structure are measured repeatedly at successive instants;
said variation is estimated repeatedly at successive instants, in which an evolution of said variation over time is analyzed with the aim of detecting any alterations in the thermal behaviour of the structure that are independent of the use of the structure.

The invention also proposes a system arranged for the analysis, in accordance with the above-mentioned method, of the thermal behaviour of a structure delimiting an enclosed space and including at least one energy-consuming appliance for providing a thermal environment by heating or cooling, the structure being modelled using a thermal model so that a relationship between a theoretical consumption by said appliance and a reference temperature inside the structure satisfies a determined criterion. The system comprises:
at least one measurement device for measuring an actual consumption by said appliance, a temperature actually obtained inside the structure and at least one parameter relating to a use of the structure;
a unit of estimation of a variation between said relationship between a theoretical consumption by said appliance and a reference temperature inside the structure on the one hand and a corresponding relationship between the actual consumption by said appliance and the temperature actually obtained inside the structure on the other hand;
a unit of estimation, when the estimated variation exceeds a threshold, of a contribution relating to the use of the structure to said variation by taking account of said measured parameter.

This system can advantageously be such that the measurement device comprises, for the measurement of at least one parameter relating to a use of the structure, at least one thermal camera arranged in order to obtain at least one image displaying a thermal distribution in the structure.

The invention also proposes a computer program product comprising suitable code instructions for implementing the above-mentioned method, when loaded and run on computerized means.

The preferred features of the above aspects which are indicated by the dependent claims may be combined as appropriate, and may be combined with any of the above aspects of the invention, as would be apparent to a person skilled in the art.

### BRIEF DESCRIPTION OF THE DRAWINGS

FIG. 1, already described, is a diagram showing the exchanges and the circulation of thermal energy capable of taking place in a structure;

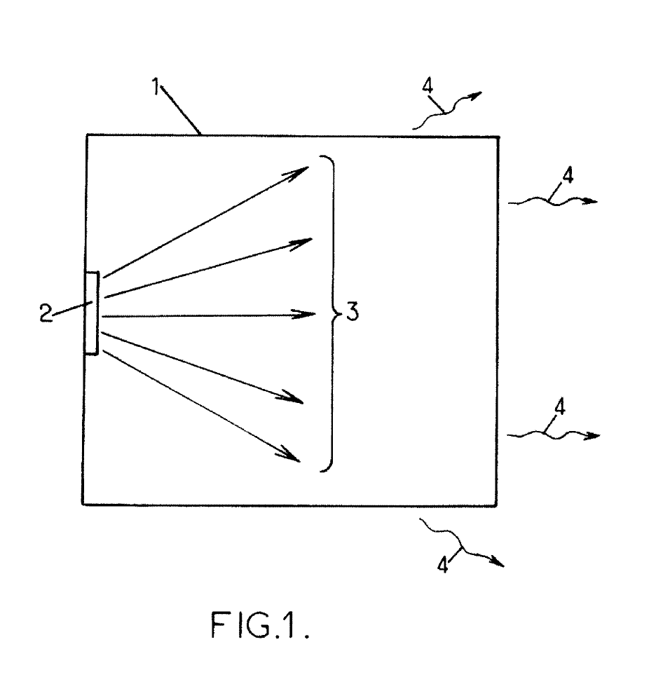

FIG. 2 is a diagram showing an example structure in respect of which the present invention can be implemented;

FIG. 3 is a diagram showing steps capable of being implemented in an embodiment of the invention.

### DESCRIPTION OF PREFERRED EMBODIMENTS

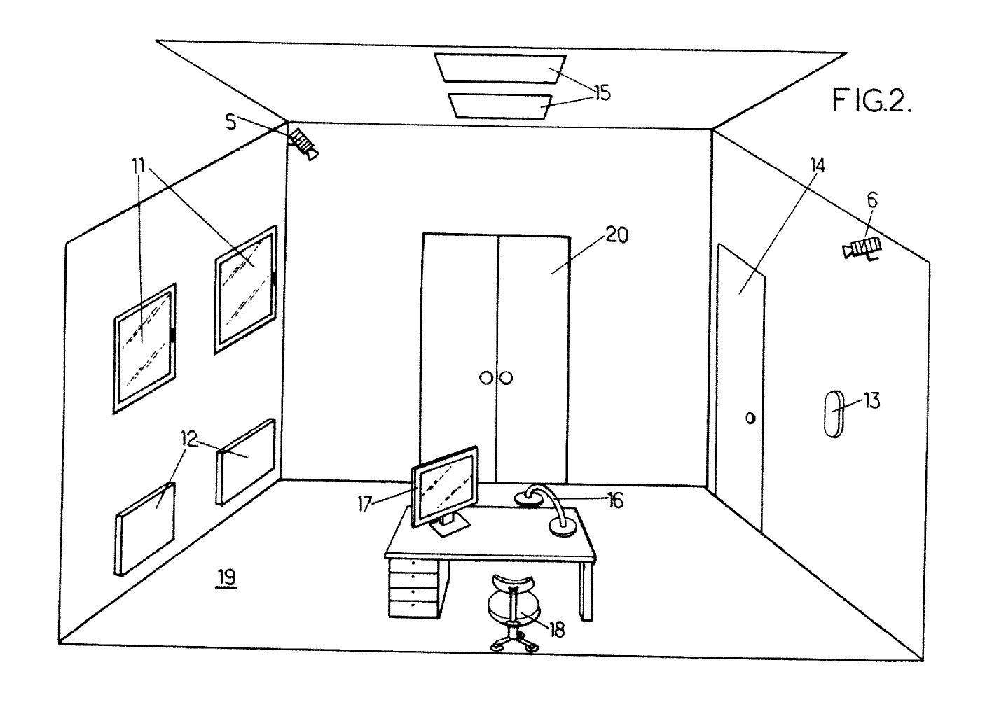

The invention relates to the analysis of the thermal behaviour of a structure delimiting an enclosed space. In the example which will be more particularly described below with reference to FIG. 2, the structure in question consists of an office, although any other type of structure (building, a hall, room, premises, structure, etc.) could be envisaged, whatever its intended purpose (residential, business, industrial or other).

The office in FIG. 2 contains two radiators 12, each consuming energy, for example electrical or other, for providing a thermal environment in the office. It will be noted that the number of radiators could be different from two and that any other type of appliance capable of providing a thermal environment by heating or cooling could be used (boiler, air-conditioning, etc.).

A device 13 for adjusting the temperature of the office, such as a thermostat, can also be used, in conjunction with the radiators 12.

The office in FIG. 2 contains moreover a certain number of elements, of which the characteristics capable of affecting the thermal behaviour are known.

In the example shown, the following elements are distinguished in particular:
windows 11, the characteristics of which comprise for example a surface, a type of glazing and/or a type of opening (sliding, opening inwards, opening outwards, etc.),
a door 14, the characteristics of which comprise for example a surface, an opening direction, a thickness and/or a material,
light fittings 15, the characteristics of which comprise for example a nominal power and/or a light intensity,
a desk lamp 16, the characteristics of which comprise for example a nominal power and/or a light intensity,
a chair or armchair 18, the characteristics of which comprise for example a volume, a material and/or the ability to be occupied by a person,
a floor covering 19, or more generally, one or more wall and/or floor coverings, the characteristics of which comprise for example a thermal conductivity, a thickness and/or a material,
a cabinet 20, or more generally, one or more thermally inert objects, i.e. capable of eventually reaching the same temperature as their environment, the characteristics of which comprise for example a volume, a weight, a material and/or a thermal conductivity.

In addition to these characteristics, it will be noted that the position of each element within the office is capable of affecting the propagation of the heat flows inside this office. In other words, the position of each element constitutes in itself a relevant characteristic with respect to the thermal behaviour of the office.

Of course, other types of elements could be contained in the office, substituting for, or in addition to, those described above.

Other characteristics can also be envisaged, such as physical properties of the office which are not listed above (presence of thermal bridges in the walls, reflective power of the exterior walls of the office, etc.).

The office in question can be modelled using a thermal model so that a relationship between a theoretical energy consumption by the radiators 12 and a reference temperature inside the office satisfies a determined criterion. This modelling can be carried out at the time of the design of the office, or later, i.e. a posteriori.

In other words, the office is supposed to meet project specifications in terms of the theoretical energy consumption by the radiators 12 and of the theoretical temperature inside the office.

For this purpose, the thermal model used advantageously takes account of the characteristics of the office, in particular of all or some of the characteristics of the elements contained in this office, as listed above. To this end, these characteristics are for example available as object attributes in a database, and can be accessed by the thermal model.

The thermal model is for example arranged in order to determine the quantity of heat (or, conversely, cold) to be generated by the appliances 12, taking account of the characteristics of each office element, the effect of each of these characteristics on the generation or the absorption of calories being predefined on the basis of theoretical data and/or the results of experiments. This type of thermal model is well known to a person skilled in the art.

There are several commercially available programs that allow this type of thermal model to be produced. The document “Peuportier B., Bancs d'essais de logiciels de simulation thermique [bench-testing thermal simulation software], SFT-IBPSA Day “Outils de simulation thermoaéraulique du bâtiment” [thermal airflow simulation tools for the construction industry], La Rochelle, March 2005” gives some of them. By way of illustrative example of a tool, reference may be made to the COMFIE software which incorporates a thermal model developed by Les Mines ParisTech. Information on this software is available at the address: http://www.izuba.fr.

The thermal model used may have been prepared after learning the energy behaviour of the office, for example by intentionally creating controlled inputs/outputs of energy (opening/closing door or windows, switching on/off of lighting, entry/exit of persons). This learning allows an initial calibration of the thermal model.

As described in the introduction, the thermal model used for designing the office can advantageously take account moreover of variable parameters capable of affecting the energy balance, such as the meteorological conditions (level of insolation, outside temperature, outside humidity, or other), simplified hypotheses relating to parameters associated with the use of the structure, or other.

By use of the structure is meant any variable phenomenon that is capable of alteration by a human intervention, for example on the initiative of an occupant of the structure, and having an effect on the heat flows in the structure.

The thermal model can thus formalize, if necessary, the relationship between the input energy, the environment, the use of the structure and the inside temperature. This model is generally applied in order to calculate, for each time step, the temperatures and heating power levels for each thermal zone, as a function of hypotheses with respect to the building, its environment and its use.

Hereinafter more particular attention will be given to the relationship between the theoretical energy consumption by the radiators 12 and the reference temperature inside the office. This relationship can adopt any form that can be envisaged. The thermal model can make it possible to verify that this relationship satisfies a criterion that is theoretically determined.

By way of non-limitative example, this relationship could be expressed as follows: the theoretical consumption C₀ by the radiators 12 remains less than a certain quantity of primary energy per unit of surface area annually (expressed for example in kWhep/m²/year) for a certain average inside reference temperature T₀ (expressed for example in degrees Celsius). This relationship can take account of a certain scenario with respect to the environmental conditions E₀, and of a certain scenario with respect to the use of the structure U₀.

According to another expression of said relationship, the ratio C₀/T₀ is less than a determined value V₀. In this case, the value V₀ can optionally depend on hypotheses formulated for at least some of the variable phenomena provided for by the above-described thermal model (in particular E₀ and U₀).

Other forms of relationship between theoretical consumption by the heating or cooling appliance(s) and the reference temperature inside the structure in question, and/or criterion to be met by said relationship could be substituted or used in addition, as will be apparent to a person skilled in the art.

If the relationship between the consumption by the heating or cooling appliance(s) and a setting (target temperature in the structure in question) is known, then the setting can be directly associated with a consumption so that the person who changes the setting can be directly informed of the difference in consumption that can be expected as a result (as an absolute value, as a percentage, cost, weight of CO₂, or other) in order to alert him to the consequences of his action. Thus actual behaviour can be verified relative to theoretical behaviour and in addition the means to influence consumption can be provided.

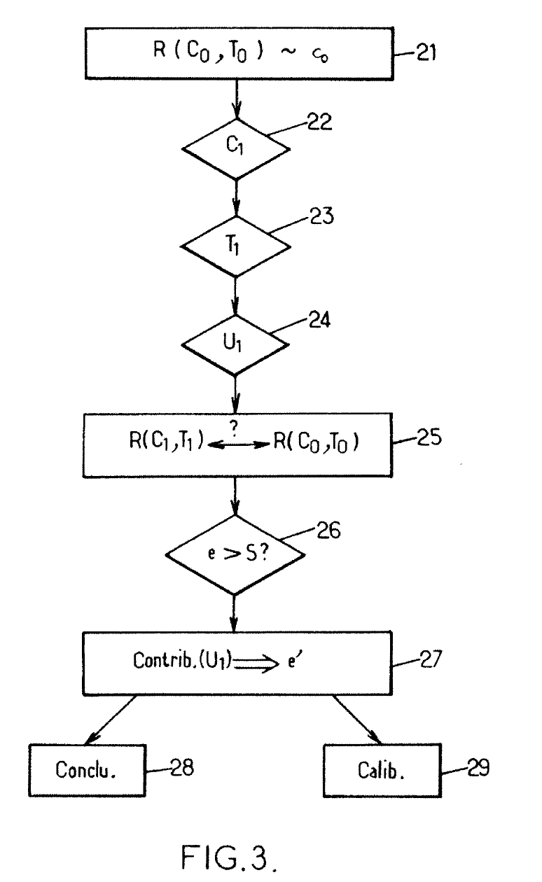

Step 21 in FIG. 3 shows the fulfilment of a criterion determined by said relationship in the following general format: R(C₀, T₀)˜c₀, where c₀ symbolizes the criterion which must be met by the relationship R between C₀ and T₀. This criterion c₀ depends optionally on at least one of the above-defined values E₀ and U₀. It will be noted that, according to another convention equivalent to the latter, it would be possible to consider a relationship R(C₀, T₀, E₀, U₀) that must satisfy a criterion c′₀ independently of the phenomena E₀ and U₀ (since the latter are then already taken into account in the relationship R).

According to the invention, this will be followed by an analysis of the thermal behaviour of the structure in question, for example of the office in FIG. 2, in the following manner.

An actual consumption C₁ by the radiators 12 is measured, as shown in step 22 in FIG. 3. This measurement can be carried out in any manner that can be envisaged, for example using an energy consumption sensor, a sensor for heat generated combined with a converter of heat into energy consumption, etc.

A temperature T₁ actually obtained inside the office is also measured simultaneously (or at instants close in time), as shown in step 23 in FIG. 3. This temperature measurement can also be carried out by any means that can be envisaged, for example using a thermometer.

Advantageously, using corresponding sensors, parameters E₁ relating to the environment of the structure, such as meteorological conditions, a thermal environment of an adjacent structure, or other, are also measured. More generally, any parameter taken into account in the thermal model used for designing the office can advantageously be the subject of a corresponding measurement using a suitable measurement means.

Additionally, at least one parameter U₁ relating to a use of the office is measured, as shown in step 24 in FIG. 3.

It will be noted that the order of steps 22 to 24 is immaterial.

All or some of these measurements can be carried out at a point in time or over any relevant period of time for observation (for example of the order of a minute, an hour, a day or more). The different measurements carried out are advantageously performed simultaneously (or almost simultaneously).

Advantageously, the actual consumption C₁ and the temperature actually obtained T₁ are measured repeatedly at successive instants. Optionally, this also applies for said parameter relating to a use U₁ and/or for the environmental conditions E₁.

The parameter(s) relating to a use of the office can for example relate to at least one from: opening/closing the door 14 or one or more of the windows 11, covering the door 14 or one or more of the windows 11 (for example using curtains or blinds), presence of at least one individual inside the office, presence of at least one indirect source of heat or cold inside the office (for example due to the fact that the light fittings 15 and/or the lamp 16 are switched on), use of at least one operational setting for the radiators 12, for example using the thermostat 13. Other parameters of use can be envisaged, substituting for, or in addition to, the latter, as will be apparent to a person skilled in the art.

An estimation of its effect on the heat balance of the office can be associated with each parameter of use. By way of example, the loss of thermal energy of the office associated with the opening of a window 11, taking account of a difference between the outside temperature and the inside temperature T₁, can be estimated. This estimation can be the result of a theoretical study or measurements carried out in the office in question or an equivalent space. According to another example, the presence of a person in the office leads to the generation of thermal energy, which can be estimated theoretically or by measurement.

The estimation of the thermal effect of each parameter of use can be stored in a database, which is for example the same as that mentioned above with reference to the elements included in the office. It will be noted furthermore that some of these parameters of use are associated with office elements (for example the light fittings 15 and the lamp 16) the characteristics of which are known and an estimation of their thermal effect can accordingly be stored in the database as attributes of the corresponding element. This estimation can for example have been obtained during the above-mentioned optional learning phase, during which an energy signature of certain office elements (lamps, door, windows, etc.) was obtained.

The estimation of the thermal effect of each parameter of use can relate to a fixed value, the order of magnitude of which is known (for example on average 90 W is dissipated from a person present in a room; 50 W for a portable computer; etc.), or to a variable value dependent on other parameters and which in this case must be determined by calculation and can be extremely variable. For example opening a window has a double effect:
thermal resistance of the wall is reduced, and
new air renewal is significantly increased.

The corresponding energy can range from a few watts to several hundred watts according to the characteristics of the project.

In a variant, it would be possible for the estimation of the thermal effect of at least some of the parameters of use not to be predetermined and stored in a database, but calculated in a practical manner, for example using suitable measurements.

Any suitable measurement means can be used for measuring all or some of the parameters of use. By way of non-limitative examples, there can be mentioned: sensors for opening/closing of door or windows, a motion detector for detecting the presence of an individual, a detector for the status of a switch controlling an appliance such as a lamp or a light fitting, a detector for a temperature setting, etc.

In an advantageous embodiment, one or more thermal cameras 5-6 can be used for measuring parameters relating to a use of the office. This can be one of the many commercially available thermal cameras. By way of examples, the following companies supply thermal cameras suitable for use within the framework of the present invention: BFi OPTiLAS, dBVib, FLIR Systems, Fluke, HGH, IMPAC, InfraTec, JCM Distribution, Land Infrarouge, LOT-Oriel, Optophase, Synergys Technologies, Testo, Trotec.

The thermal cameras 5-6 are for example infrared cameras, capable of delivering images allowing a measurement of the temperature at each of their points to be obtained quite directly. The images obtained display a thermal distribution in the office, which gives a measurement of the temperature of each of the office elements.

The positioning of the windows 11 and in particular of the panes makes it possible optionally to take account of the reflexion of the thermal image, so as not to consider an image of a source as a heat source.

The thermal camera(s) 5-6 used are for example fixed in relation to the office, so that all the objects observed on the delivered images are fixed and known and they correspond to the listed office elements.

Advantageously, an infrared image delivered by a thermal camera is superimposed on a standard image of the office, so as to associate with each office element an infrared image thereof. An item of thermal information is thus associated visually with each listed office element.

This information can be made dynamic, if successive thermal images are captured as time elapses. The analysis of the successive images makes it possible to follow the temperature variation as a function of time, which can constitute exploitable information (thermal inertia of the objects for example).

The thermal images delivered by the thermal cameras 5-6 can make it possible to visualize what in the office has heated up or cooled down, for how long, how the flux is distributed according to which objects and the status of the objects, and under what successive conditions a target temperature (shown by a setting desired by a user) was reached or maintained.

In order to protect the identity of the persons who may be present in the office in question or other types of information that may be of a confidential nature, the thermal images delivered by the thermal cameras 5-6 are advantageously obtained in encrypted form, for example using an encryption algorithm. The decryption key for this algorithm would not be public and would be known only to the thermal image analysis program. Thus it is possible to avoid complaints that the thermal images would disclose, for example, the activity of the persons present in the office.

The thermal images obtained can in particular be used for measuring the parameter(s) U₁ relating to a use of the office.

In order to carry out this measurement, it is possible for example to compare a thermal image obtained using a thermal camera with an expected thermal image. The latter for example takes account of the presence and location in the office of the radiators 12 (or any other energy-consuming appliance for providing a thermal environment by heating or cooling).

The expected image can for example show a distribution of the heat flows in the event of the windows 11 being closed. If, in reality, the windows 11 are open, the thermal image delivered by a thermal camera will display a temperature variation close to these windows. This already gives an indication of use, namely that the windows 11 are open. The comparison between the delivered image and the expected image moreover makes it possible, for example by direct subtraction between the values measured at each point, to assess the extent of the temperature variation. This is a relatively accurate parameter of use that can be exploited quite easily, in order to determine the contribution of opening the windows to the thermal behaviour of the office, a concept that will be detailed below.

A relationship between the actual consumption C₁ by the radiators 12 and the temperature T₁ actually obtained inside the office, as measured in steps 22 and 23, is then assessed. This relationship can be the same as the relationship R satisfied by the theoretical consumption C₀ and the reference temperature T₀, as mentioned with reference to step 21. In a variant, this relationship could correspond to the relationship R, without necessarily being identical thereto. By way of example, this relationship could correspond to the relationship R, with a conversion and/or a normalization.

When parameters relating to the environment of the office, such as meteorological conditions or a thermal environment of an adjacent structure, are measured using corresponding sensors, the relationship between the actual consumption C₁ by the radiators 12 and the temperature T₁ actually obtained inside the office can advantageously take account of at least some of these parameters. By way of example, if the relationship R(C₀, T₀) used in step 21 was estimated for an outside temperature of 20° C., and the actual outside temperature is only 10° C., this temperature variation can be taken into account in the evaluation of the relationship R(C₁,T₁), such that these two relationships can be compared.

The two relationships are compared in step 25, in order to deduce a variation e therefrom.

If, for example, the relationship mentioned in step 21 refers to the ratio C₀/T₀ (which must for example be less than a value V₀), it is possible in step 25 to calculate the ratio C₁/T₁. The difference C₀/T₀−C₁/T₁ then gives a variation e between the two relationships. If it is found that the temperature measured in the office is equal to the reference temperature, i.e. T₀=T₁, the variation e then corresponds to a simple difference between the theoretical C₀ and actual C₁ consumptions by the heating or cooling appliances.

A comparison between the estimated variation e and a threshold S is carried out in step 26. The threshold S is advantageously chosen for detecting or anticipating a deviation of the thermal behaviour of the office. Thus, beyond this threshold S, the actual consumption C₁ could be considered to be abnormally high compared with the theoretical consumption C₀.

The threshold S can adopt an absolute value or even a relative value taking account for example of at least some of the values V₀ (or more generally c₀), C₀, T₀, C₁ and T₁. By way of example, if the variation e corresponds to a simple difference between the theoretical C₀ and actual C₁ consumptions by the heating or cooling appliances, the threshold S could correspond to a fixed value, expressed for example in kWh, a percentage of the theoretical consumption C₀, for example of the order of 10% to 20%, or other.

When the actual consumption C₁, the temperature actually obtained T₁ and optionally said parameter relating to a use U₁ have been measured simultaneously in repeated fashion at successive instants, the variation e can also advantageously be estimated repeatedly at successive instants. An analysis of the evolution of this variation e over time can be carried out with the aim of detecting any alterations in the thermal behaviour of the office that are independent of the use of the office.

If the variation e exceeds the threshold S, which can reflect for example an actual consumption C₁ that is potentially abnormally high compared with the theoretical consumption C₀, a contribution relating to the use of the office to this variation e is estimated in step 27. In other words, it is sought to discover if the high value for the variation can be explained by an atypical use of the office, and in what proportion.

In order to estimate the contribution of the use of the office to the variation e, account is taken of the previously measured parameter(s) U₁ as mentioned with reference to step 24. This estimation can adopt any form that can be envisaged, as a function for example of the nature of the relationships R(C₀,T₀) and R(C₁,T₁), the variation e, and/or the parameter U₁ itself.

Turning purely for the purposes of illustration to a situation where the variation e corresponds to a difference between the actual consumption C₁ and the theoretical consumption C₀ by the radiators 12 of 10 kWh (with T₀=T₁), which exceeds a threshold S for example of 8 kWh. Moreover, the parameter U₁ measured in step 24 reflects opening of the windows 11 situated above the radiators 12.

Such opening of the windows 11, while the outside temperature, optionally measured, is assumed to be colder than the inside temperature T₁, results in a loss of thermal energy from the office which can be known, either because an estimation thereof is already available (for example in the database that can be accessed by the thermal model of the office), or because it is the subject of a practical evaluation, for example based on suitable measurements.

This loss of thermal energy associated with the opening of the windows 11 is compensated for by an equivalent production of thermal energy via the radiators 12. As the characteristics of the radiators 12 are known, it is possible to easily deduce therefrom the energy consumption by the radiators 12 required for said thermal energy production.

For instance, if this additional energy consumption by the radiators 12, compared with a situation where the windows 11 are closed, is estimated as 5 kWh, then, by comparing this value to that of the variation e which is 10 kWh, it is observed that the contribution of the opening of the windows to this variation is 5 kWh, i.e. 50%.

If there is no other parameter of use available or forming part of the variation e, it is possible to deduce therefrom that the contribution relating to the use of the office to the variation is 5 kWh, i.e. 50%. Conversely, i.e. if other types of use are involved and form part of the variation e observed, the total contribution relating to the use of the office is greater than 5 kWh, and can be evaluated in greater detail by an analysis of each individual contribution from each measured parameter of use U₁.

Once the contribution relating to the use of the office to the variation e has been estimated, a corrected variation e′ can advantageously be calculated in order to take account of this contribution. Such a corrected variation e′ disregards the influence of the use of the office. For this purpose, the contribution relating to the use of the office can for example be subtracted from the variation e.

In the example described above, the contribution relating to the use of the office was 5 kWh for a variation e of 10 kWh. The corrected variation e′, which corresponds to the difference between the two values, therefore amounts to 5 kWh.

It will be noted that subtracting the contribution relating to the use of the office from the variation e can adopt forms other than a simple difference between two values, as will be apparent to a person skilled in the art.

Several actions are then possible, based on the corrected variation e′, or based on any other quantity which would disregard the effect of the use of the office. Two possibilities for actions are mentioned hereinafter, although other types of action can be envisaged, as will be apparent to a person skilled in the art.

According to a first possibility, a conclusion on the design of the office can be deduced from the corrected variation e′, as shown in step 28.

This conclusion can for example result from a comparison of the corrected variation e′ with the above-mentioned threshold S. In the numerical example considered here, the corrected variation e′ has a value of 5 kWh which is less than that of the threshold S (namely 8 kWh).

When the threshold S was set in order to detect a deviation in the thermal behaviour of the office, the comparison carried out in step 24 on the basis of the variation e would possibly have led to the incorrect conclusion that the design of the office did not conform to the project specifications (R(C₀,T₀)˜c₀).

But taking account of the contribution of the use of the office, in this case the opening of the windows 11, makes it possible to observe that the corrected variation e′, taking account of this use, is in reality below the threshold S. In other words, the thermal behaviour of the office conforms to expectations if the effect of the use of this office, which could not be precisely anticipated at the time of design, is taken into account.

Conversely, a corrected variation e′ that is even higher than the threshold S could be interpreted as a design fault of the office, apparent from inception or resulting from a more or less rapid deterioration (that it is possible to detect for example thanks to an analysis of the evolution of the variation over time, as mentioned above). The extent of the corrected variation e′, optionally complemented by additional investigations, (series of measurements, or other) can allow the causes of the deviation to be understood or even corrected.

According to a second possibility, not incompatible with the previous one, the thermal model is modified in order to take account of the corrected variation e′ as shown in step 29.

It will be recalled that the thermal model used for designing the office formalizes the relationship between the input energy, the environment, the use of the office and the inside temperature.

The corrected variation e′ allows the thermal behaviour of the office to be known, by disregarding the contribution relating to the use of the office. A value for this corrected variation e′ that is too large can be explained by a lack of relevance or reliability of the thermal model used for designing the office.

An analysis of the corrected variation e′ then makes it possible, optionally using additional investigations, to calibrate the thermal model so that it corresponds better to reality.

By way of example, it is possible that the project specifications R(C₀,T₀)˜c₀ were incorrectly estimated, for example due to the office elements and/or at least some of their characteristics having been inadequately taken into account by the thermal model. A correction of the thermal model can then be envisaged so that it more accurately models the actual observed situation.

After calibration of the thermal model, the calculated variations e and e′ should better represent the actual thermal behaviour of the office.

The calibration of the thermal model can be carried out continuously or regularly by successive iterations for example.

Calibration by iteration is generally carried out by an expert and consists of manually iterating the input parameters of the thermal model in order to more closely approach the true situation experimentally measured. For example, if it is observed that the energy requirement is greater than forecast in a given environmental and use scenario, it is possible that this arises from the presence of thermal bridges that are more significant than expected, or the use of materials that are less insulating than expected. The expert must in this case analyze the possibilities, carry out verifications in order to reduce the range of possibilities, and finally produce simulations with different sets of hypotheses in order to more closely approach the model of the actual situation measured. These iterations can be carried out manually or programmed in order to be performed systematically.

Automatic calibration can also be performed by inversion of the direct model. The direct thermal models make it possible to calculate an energy requirement for a given building, a given temperature setting, a given environment and a given use. An example of an inverse model would be a model the input data of which would be the measured environment, the measured use, and the measured temperature setting. In this model, some of the descriptive parameters would be assumed to be known, and others would be calculated.

It will be noted that the operations described above can be implemented for any system whether simple (device) or complex (set of devices), comprising suitable units (device for measuring C₁, T₁ and U₁, unit for estimating the variation e, unit for estimating a contribution relating to use, etc.).

A computer program can be used for implementing the present invention, when loaded and run on computerized means. To this end it uses suitable code instructions.

1. Method for the analysis of the thermal behaviour of a structure delimiting an enclosed space and including at least one energy-consuming appliance for providing a thermal environment by heating or cooling, the structure being modelled using a thermal model so that a relationship between a theoretical consumption by said appliance and a reference temperature inside the structure satisfies a determined criterion, the method comprising:
measuring an actual consumption by said appliance, a temperature actually obtained inside the structure and at least one parameter relating to a use of the structure;
estimating a variation between said relationship between a theoretical consumption by said appliance and a reference temperature inside the structure on the one hand and a corresponding relationship between the actual consumption by said appliance and the temperature actually obtained inside the structure on the other hand; and
when the estimated variation exceeds a threshold, estimating a contribution relating to the use of the structure to said variation by taking account of said measured parameter.

2. Method according to claim 1, in which a corrected variation is moreover calculated by subtracting from said estimated variation the contribution relating to the use of the structure.

3. Method according to claim 2, in which a conclusion is deduced with respect to the design of the structure, from the corrected variation.

4. Method according to claim 2, in which the thermal model is modified in order to take account of the corrected variation.

5. Method according to claim 1, in which moreover, using corresponding sensors, parameters relating to the environment of the structure are measured, such as meteorological conditions or a thermal environment of an adjacent structure, and in which said relationship between the actual consumption by said appliance and the temperature actually obtained inside the structure takes account of at least some of these parameters.

6. Method according to claim 1, in which said parameter relating to a use of the structure relates to at least one of: an opening/closing of at least one door or window in the structure, covering at least one door or window in the structure, presence of at least one individual inside the structure, presence of at least one indirect source of heat or cold inside the structure, use of at least one operational setting for said appliance;

7. Method according to claim 1, in which at least one image is obtained displaying a thermal distribution in the structure by means of at least one thermal camera, said obtained image being used in order to measure said parameter relating to a use of the structure.

8. Method according to claim 7, in which said parameter relating to a use of the structure is measured based on a comparison between said obtained image and a corresponding expected image.

9. Method according to claim 8, in which said expected image takes account of the presence and the location in the structure of said energy-consuming appliance for providing a thermal environment by heating or cooling.

10. Method according to claim 7, in which said obtained image is in an encrypted form.

11. Method according to claim 1, in which the actual consumption by said appliance and the temperature actually obtained inside the structure are measured repeatedly at successive instants.

12. Method according to claim 11, in which said variation is estimated repeatedly at successive instants, and in which an evolution of said variation over time is analyzed with the aim of detecting any alterations in the thermal behaviour of the structure that are independent of the use of the structure.

13. System arranged for the analysis of the thermal behaviour of a structure delimiting an enclosed space and including at least one energy-consuming appliance for providing a thermal environment by heating or cooling, the structure being modelled using a thermal model so that a relationship between a theoretical consumption by said appliance and a reference temperature inside the structure satisfies a determined criterion, the system comprising:
at least one measurement device for measuring an actual consumption by said appliance, a temperature actually obtained inside the structure and at least one parameter relating to a use of the structure;
a unit of estimation of a variation between said relationship between a theoretical consumption by said appliance and a reference temperature inside the structure on the one hand and a corresponding relationship between the actual consumption by said appliance and the temperature actually obtained inside the structure on the other hand;
a unit of estimation, when the estimated variation exceeds a threshold, of a contribution relating to the use of the structure to said variation by taking account of said measured parameter.

14. System according to claim 13, in which said measurement device comprises, for the measurement of at least one parameter relating to a use of the structure, at least one thermal camera arranged in order to obtain at least one image displaying a thermal distribution in the structure.

15. Computer program product comprising suitable code instructions for carrying out, when loaded and run on computerized means:
measuring an actual consumption by said appliance, a temperature actually obtained inside the structure and at least one parameter relating to a use of the structure;
estimating a variation between said relationship between a theoretical consumption by said appliance and a reference temperature inside the structure on the one hand and a corresponding relationship between the actual consumption by said appliance and the temperature actually obtained inside the structure on the other hand; and
when the estimated variation exceeds a threshold, estimating a contribution relating to the use of the structure to said variation by taking account of said measured parameter.
